(19) United States
(12) Patent Application Publication
(10) Pub. No.: US 2012/0217905 A1
(43) Pub. Date: Aug. 30, 2012

(54) Electric Vehicle Self Charging System

(76) Inventor: Douglas Anthes, Davenport, IA (US)

(21) Appl. No.: 13/214,953

(22) Filed: Aug. 22, 2011

Related U.S. Application Data
(60) Provisional application No. 61/375,810, filed on Aug. 21, 2010.

(51) Int. Cl. H02P 1/00; H02J 7/00

(52) U.S. Cl. 318/139; 320/107

(57) ABSTRACT

A self-charging system for an electric vehicle comprising: an alternator system, or said alternator system is connected to one axle of the vehicle; a distribution module, where the distribution module receives power from the alternator system; and a battery charger apparatus, where said battery charger apparatus charges a battery pack, when the battery pack power drops to a predetermined level and the charger receives power via the distribution module. The self-charging system may further include a motor, where the motor provides power to a drive chain of the vehicle and receives power from the battery pack. The motor receives power supplied by the alternator system via the distribution module after the battery pack is fully charged. Preferably, the alternator system initiates supply of power to the distribution module at a predetermined RPM.

### CROSS REFERENCE TO OTHER APPLICATIONS

This application claims priority to U.S. Provisional Application Ser. No. 61/375,810 filed on Aug. 21, 2010.

### BACKGROUND OF THE INVENTION

1. Field of Invention

The present invention relates to a system that assists in the charging of a battery used to power an electric vehicle.

2. Description of Related Art

Electric vehicles, especially automobiles, are becoming popular and more prevalent due to increased energy costs and concern regarding the reduction of green house gas emissions. Electric vehicles are powered by batteries that are contained with the vehicle and usually provide an adequate charge for the propulsion of the vehicle through city traffic. The batteries are mounted within the vehicle and are used to propel the car as an alternative to using an internal combustion engine. Although electric cars are increasing in popularity, the electric car has been available since the invention of motor vehicles in the early 1900's. Actually many electric cars were the standard in earlier automotive production at the turn of the century before the internal combustion engine took over as the predominant means for propulsion of a motor vehicle. Electric vehicles were found in the initial fleet of New York City taxicabs and competed with the internal combustion engine until the 1920's.

Even the earlier reviews of electric cars clearly stated that the electric car was ideal because it was cleaner, quieter and more economic means of transportation as opposed to the internal combustion engine. The modern electric car has been recently introduced as a hybrid where the vehicle is capable of operating on via electrical power or an internal combustion engine. The hybrid technologies allow for the use of electric propulsion at lower speeds and conversion to the internal combustion engine at higher speeds, therefore extending the drive time for the electric car. More recently, total electric cars are being introduced on the market to completely eliminate the use of internal combustion.

One drawback to electric cars is that batteries must be recharged and there are limitations in the range that the battery may propulse the vehicle without recharging. One solution to this recharging problem is to have an interchangeable battery that may be replaced with the charged battery, similar to filling up a tank with gasoline. Some of the earlier designs of electric cars included a means to charge the vehicle using kinetic energy generated by the vehicle itself. Such a device installed on a modern electric car may therefore increase the range of the battery and provide an effective means to recharge the battery while the vehicle is in motion.

### SUMMARY OF THE INVENTION

The present invention relates to a self-charging system for an electric vehicle comprising: an alternator system, where said alternator system is connected to one axle of the vehicle; a distribution module, where the distribution module receives power from the alternator system; and a battery charger apparatus, where said battery charger apparatus charges a battery pack, when the battery pack power drops to a predetermined level and the charger receives power via the distribution module.

The self-charging system may further include a motor, where the motor provides power to a drive chain of the vehicle and receives power from the battery pack. The motor receives power supplied by the alternator system via the distribution module after the battery pack is fully charged. Preferably, the alternator system initiates supply of power to the distribution module at a predetermined RPM.

### BRIEF DESCRIPTION OF DRAWINGS

FIG. 1 depicts a self-charging system installed on a four-wheel vehicle in accordance with the present invention.

### DETAILED DESCRIPTION

The present invention relates to a vehicle self-charging system that uses a modified alternator system to provide power for both an electric motor and alternatively charge a battery pack of an electric car. The self-charging system according to present invention provides an modified alternator which is attached to axle of the vehicle through the use of a serpentine belt.

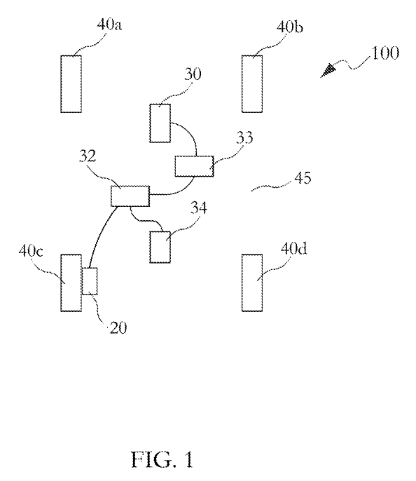

As shown in FIG. 1, the charging system 100 utilizes energy that is generated through an alternator system 20. The alternator system 20 includes alternator that generates power supplies to a distribution module 32. The alternator system 20 includes an alternator that is connected to a serpentine belt where the serpentine belt connects to a pulley of the alternator at one end and connects to a pulley attached to the axle of wheel 40c. Although not shown in detail, the serpentine belt moves in accordance with the axle of the wheel 40c. In one particular embodiment, the wheel 40c is one of a set of front wheels as shown in FIG. 1. Wheels 40c, 40d may be provided as front wheels of the vehicle 45.

The charging system 100 operates in the following manner. The alternator system 20 supplies energy to the distribution module 32. This distribution module 32 directs the power generated by alternator system 20 to either a motor 34 or a battery charging apparatus 33. The battery charger apparatus 33 charges a battery pack 30, where the battery pack 30 supplies power to the motor 34. The distribution module 32 along with appropriate sensors determine the direction or flow of power generated by the alternator system 20.

Initially the operation of the vehicle 45 is accomplished by power supplied by battery pack 30 as power energizes the motor 34 for operation at lower speeds of operation. Once the vehicle reaches a predetermined RPM, the alternator system 20 initiates the generation of energy for distribution within the system. While the vehicle initially operates on the battery pack 30, once the alternator system 20 is activated for use, the vehicle may receive to the motor 34 through the distribution module 32. Sensors are provided to monitor the battery strength of the battery pack 30. Upon reaching a predetermined energy level, the battery charger 33 charges the battery pack 33 to full capacity. Once the battery pack 33 reaches full capacity then any energy generated by the alternator system 20 is directed to the motor and therefore supplies 100 percent of the energy for the motor 34 during operation.

As stated above, vehicle 45 includes four wheels, front wheels 40c, 40d and a set of rear wheels 40a, 40b. This unique system of charging the electric vehicle helps to provide a longer operation cycle for the vehicle and eliminates the necessity for a direct connection to recharge the battery pack 30. As stated during operation, the battery pack 33 supplies power for the motor 34 at low speeds or RPMs. Once the vehicle reaches a certain threshold speed, the alternator system 20 then first recharges the battery pack 30 if the battery pack 30 has a diminished capacity below a predetermined level. Consequently, the motor 34 will continue to operate on the battery pack 30 as it is also being charged by the alternator system 20. Once the battery pack 30 reaches full capacity the distribution module 32 redirects energy to the motor 34 and the motor 34 therefore then runs off the energy generated directly by the alternator system 20. The charging system according to the present invention therefore helps to supply the continuous flow of energy to the motor 34 and also provides an internal self-charging system for the battery pack 30. The present invention alleviates the need for powering or charging the battery pack 30 through an outside source. Further due to the self-charging alternator system 20, the vehicle can receive power directly from the alternator and therefore be provided power for longer trips especially at higher speeds where the alternator remains activated. In one particular embodiment, the alternator supplies power for the battery pack once the levels of the battery pack reach in the range of 50 or 75 percent of power capacity. Initiating charging at these levels ensures that the battery is available for use by the motor while being charged to capacity by the alternator system 20. Consequently, based on the foregoing the self-charging system and present invention is unique in providing long-term continuous power for motor of an electrical vehicle.

The self-charging system according to present invention produces a cost-efficient device that increase the miles per charge available on an electric car battery pack. By increasing the miles per charge on the battery pack, this in turn increases the efficiency and helps to promote the use of electric cars. By increasing a more wide use of electric cars, the quality of the environment may improve by reducing fumes and toxins emitted due to the diminished use of the internal combustion engine. Use of self-charger system in accordance with the present invention, therefore may help to increase the use of electric vehicles in the future. The instant invention has been shown and described in what it considers to be the most practical and preferred embodiments. It is recognized, however, that departures may be made there from within the scope of the invention and that obvious modifications will occur to a person skilled in the art.

What is claimed is:

1. A self-charging system for an electric vehicle comprising:
a. an alternator system, where said alternator system is connected to one axle of the vehicle;
b. a distribution module, where the distribution module receives power from the alternator system; and
c. a battery charger apparatus, where said battery charger apparatus charges a battery pack, when the battery pack power drops to a predetermined level and the charger receives power via the distribution module.

2. The self-charging system according to claim 1 further including, a motor, where the motor provides power to a drive chain of the vehicle and receives power from the battery pack.

3. The self-charging system according to claim 2, where the motor receives power supplied by the alternator system via the distribution module after the battery pack is fully charged.

4. The self-charging system according to the claim 1, where said alternator system initiates supply of power to the distribution module at a predetermined RPM.
